(19) United States
(12) Patent Application Publication
(10) Pub. No.: US 2016/0316513 A1
(43) Pub. Date: Oct. 27, 2016

(54) COMMUNICATION DEVICE AND METHOD FOR CONTROLLING THE SAME

(71) Applicant: Samsung Electronics Co., Ltd., Gyeonggi-do (KR)

(72) Inventors: Heun-Chul LEE, Gyeonggi-do (KR); Sung-Soo KIM, Seoul (KR); Jong-Han LIM, Seoul (KR)

(73) Assignee: Samsung Electronics Co., Ltd.

(21) Appl. No.: 15/137,388

(22) Filed: Apr. 25, 2016

Related U.S. Application Data
(60) Provisional application No. 62/151,643, filed on Apr. 23, 2015.

(30) Foreign Application Priority Data
Dec. 29, 2015 (KR) 10-2015-0188999

(51) Int. Cl. H04W 76/04; H04W 72/12; H04W 72/04

(52) U.S. Cl. CPC H04W 76/046; H04W 72/042; H04W 72/1247

(57) ABSTRACT

Methods and apparatuses are provided for controlling a communication device. First data corresponding to at least one first UE and second data corresponding to at least one second UE are superposed at a bit level to generate superposed data. The superposed data is modulated. The modulated data is transmitted to the at least one first UE and the at least one second UE.

### PRIORITY

This application claims priority under 35 U.S.C. §119(e) to U.S. Provisional Application No. 62/151,643, filed in the U.S. Patent and Trademark Office on Apr. 23, 2015, and claims priority under 35 U.S.C. §119(a) to Korean Patent Application No. 10-2015-0188999, filed in the Korean Intellectual Property Office on Dec. 29, 2015, the contents of which are incorporated herein by reference.

### BACKGROUND

1. Field of the Disclosure

The present disclosure relates generally to a communication device and a method for controlling the same, and more particularly, to a communication device and a method for improving a throughput of a cell edge.

2. Description of the Related Art

A long term evolution (LTE) or LTE-advanced (LTE-A) system (as used herein, an “LTE system”) is capable of supporting a broad bandwidth having carriers up to 100 MHz and high-order spatial multiplexing over a maximum of eight layers in a downlink (DL). In the LTE system, generally, a precoding-based approach is used to achieve spatial orthogonality between a plurality of user equipments (UEs) for simultaneous transmission. The precoding-based approach requires all channel state information (CSI) of DL channels. However, since the CSI is estimated and quantized by the UEs, and reported to a base station (BS) through a limited feedback channel, the CSI may be outdated and may not be accurate. To overcome these drawbacks, a research item referred to as “downlink multi-user superposition transmission (MUST)” has been developed in the 3^{rd} generation partnership project (3GPP). The main goal of “MUST” simultaneously satisfies the requirements of both a cell average spectrum efficiency and a cell edge user spectral. Since the downlink transmission is limited by inter-cell interference between cellular networks, the cell edge user spectral efficiency is achieving greater importance.

To meet the increasing demand for high spectral efficiency, the LTE system supports high-order modulation levels including 4 quadrature amplitude modulation (QAM), 16QAM, 64QAM, and 256QAM. The LTE system employs gray coding for bit-to-symbol mapping. The gray-coded QAM scheme provides different protection levels to coded bits. For example, respective gray-coded 16QAM symbols may be expressed as four bits that generate different projection levels, in which the two first bits may be safer than the other two bits in terms of radio channel fading and noise. Other modulation schemes, such as 64QAM and 256QAM, provide three and four different protection levels.

FIG. 1 is a diagram illustrating downlink MUST at a symbol level (or in a symbol domain). Referring to FIG. 1, a device for performing MUST may include a scrambling module 110, a modulation mapper 112, a layer mapper 114, a multiplier 116, a adder 118, a precoding module 120, a resource element mapper 122, an OFDM module 124 and an antenna 126. Data 101 for a primary UE and data 103 for a secondary UE are pre-coded in a superposed manner with respect to each other, and are transmitted to the respective UEs. In FIG. 1, an adder (or an addition function/operation) 110 may perform a function or an operation of superposing the data 101 for the primary UE and the data 103 for the secondary UE with respect to each other, prior to precoding 112. A transmission signal vector xₖ for a superposition signal may be expressed as Equation (1) below:

xₖ=\sqrt{α}xₖ^{s}+\sqrt{(1−α)}xₖ^{p} (1),

where xₖ^{p} and xₖ^{s} represent a transmission signal vector for the primary UE and a transmission signal vector for the secondary UE, respectively, herein, the term “primary UE” may refer to a UE located at a cell edge or at the periphery of the cell edge (which may be referred to as a “cell edge domain”) in a cell domain, and the term “secondary UE” may refer to a UE located in a domain other than the cell edge domain (which may be referred to as a “cell interior domain”).

With respect to MUST, in the symbol level, there may be issues such as power optimization for determining a power factor α, a need for new signaling for the power factor α, a need for changing design to adaptively generate and detect constellation points with different powers given by the power factor α, and compatibility with legacy UEs.

### SUMMARY

An aspect of the present disclosure provides a communication device and a method that provides a network system having an improved system throughput by performing superposition coding, or MUST, at a bit level.

According to an aspect of the present disclosure, a communication device is provided that includes a transceiver and a processor, electrically connected with the transceiver. The processor is configured to superpose first data corresponding to at least one first UE and second data corresponding to at least one second UE at a bit level to generate superposed data, to modulate the superposed data, and to transmit the modulated data to the at least one first UE and the at least one second UE.

According to another aspect of the present disclosure, a method is provided for controlling a communication device. First data corresponding to at least one first UE and second data corresponding to at least one second UE are superposed at a bit level to generate superposed data. The superposed data is modulated. The modulated data is transmitted to the at least one first UE and the at least one second UE.

According to an additional aspect of the present disclosure, a method is provided for controlling a communication device. First data corresponding to at least one first UE and second data corresponding to at least one second UE are scrambled. The scrambled first data and the scrambled second data are superposed in a bit domain to generate superposed data. The superposed data is mapped between a specified number of layers. The superposed data mapped between the specified number of layers is precoded to generate precoded data. The precoded data is transmitted to the at least one first UE and the at least one second UE

### BRIEF DESCRIPTION OF THE DRAWINGS

The above and other aspects, features, and advantages of the present disclosure will be more apparent from the following detailed description when taken in conjunction with the accompanying drawings, in which:

FIG. 1 is a diagram illustrating MUST at a symbol level;

FIG. 2A is a diagram illustrating a communication device, according to an embodiment of the present disclosure;

FIG. 2B is a diagram illustrating a user equipment (UE) including a communication device, according to an embodiment of the present disclosure;

FIG. 2C is a diagram illustrating a network system, according to an embodiment of the present disclosure;

FIG. 3 is a diagram illustrating a function or an operation of transmitting UE capability information for bit-domain multi-user transmission, according to an embodiment of the present disclosure;

FIG. 4 is a diagram illustrating a function or an operation of a processor that performs bit-domain multi-user transmission, according to an embodiment of the present disclosure;

FIG. 5 is a diagram illustrating a function or an operation of performing superposition coding in a bit domain, according to an embodiment of the present disclosure;

FIG. 6 is a diagram illustrating a function or an operation of transmitting information elements (IEs) necessary for a primary UE and a second UE based on radio resource control (RRC) signaling, and transmitting identification (ID) information for selecting a primary UE mode or a secondary UE mode to each UE based on downlink control information (DCI) signaling, for bit-domain multi-user transmission, according to an embodiment of the present disclosure;

FIG. 7 is an diagram illustrating a function or an operation of transmitting IEs necessary for a primary UE and a secondary UE and ID information based on DCI signaling for bit-domain multi-user transmission, according to an embodiment of the present disclosure;

FIG. 8 is a diagram illustrating DCI signaling for bit-domain multi-user transmission including a legacy UE that does not support bit-domain multi-user transmission, according to an embodiment of the present disclosure;

FIG. 9 is a diagram illustrating a mapping structure of resource blocks for co-scheduling of bit-domain multi-user transmission, according to an embodiment of the present disclosure;

FIG. 10 is a diagram illustrating multi-user detection for a secondary UE, according to an embodiment of the present disclosure;

FIG. 11A is a diagram illustrating a transmission scheme that supports one UE for each beam domain formed by full dimension (FD)-multiple input multiple output (MIMO), according to an embodiment of the present disclosure; and

FIG. 11B is a diagram illustrating a multi-user transmission scheme supporting a plurality of UEs for each beam domain formed by FD-MIMO, to which a bit-domain multi-user transmission scheme is applied, according to an embodiment of the present disclosure.

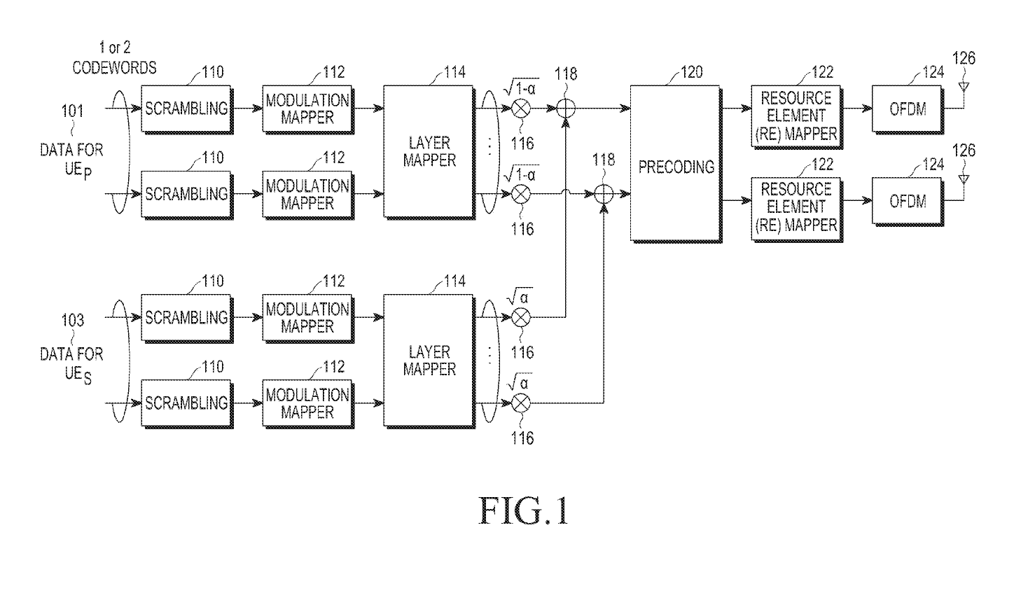

### DETAILED DESCRIPTION

Embodiments of the present disclosure are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present disclosure.

Herein, expressions such as “having,” “may have,” “comprising,” and “may comprise” indicate the existence of a corresponding characteristic (such as an element such as a numerical value, function, operation, or component), and do not exclude the existence of additional characteristic.

Herein, an expressions such as “A or B,” “at least one of A and B,” and “one or more of A and B” may include all possible combinations of listed items. For example, “A or B,” “at least one of A and B,” or “one or more of A and B” may indicate (1) at least one A, (2) at least one B, or (3) both at least one A and at least one B.

Expressions such as “first,” “second,” “primarily,” or “secondary,”, as used herein, may represent various elements regardless of order and/or importance and do not limit the corresponding elements. The expressions may be used for distinguishing one element from another element. For example, a first user device and a second user device may represent different user devices regardless of their order or importance. For example, a first element may be referred to as a second element without deviating from the scope of the present disclosure, and similarly, a second element may be referred to as a first element.

When it is described that an element (such as a first element) is “operatively or communicatively coupled” or “connected” to another element (such as a second element), the element can be directly connected to the other element or can be connected to the other element through a third element. However, when it is described that an element (such as a first element) is “directly connected” or “directly coupled” to another element (such as a second element), it means that there is no intermediate element (such as a third element) between the element and the other element.

The expression “configured to (or set)”, as used herein, may be used interchangeably with, for example, “suitable for,” “having the capacity to,” “designed to,” “adapted to,” “made to,” or “capable of according to a situation. The expression “configured to (or set)” does not always mean “specifically designed to” by hardware. Alternatively, in some situations, the expression “apparatus configured to” may mean that the apparatus “can’ operate together with another apparatus or component. For example, a phrase “a processor configured (or set) to perform A, B, and C” may be a generic-purpose processor (such as a central processing unit (CPU) or an application processor) that can perform a corresponding operation by executing at least one software program stored at an exclusive processor (such as an embedded processor) for performing a corresponding operation or at a memory device.

Terms defined herein are used to describe a specific embodiment and are not intended to limit the scope of other embodiments. A singular form may also include plural forms unless it is explicitly differently represented. Technical and scientific terms, used herein, may have the same meanings as those generally understood by a person of common skill in the art. Terms defined in a dictionary have the same meanings as or similar meanings to that of a context of related technology and are not to be analyzed as having ideal or excessively formal meanings unless explicitly defined. In some case, terms defined herein cannot be analyzed to exclude the present embodiments.

Herein, the term “user” may indicate a person who uses a communication device, a device or apparatus using a communication device (e.g., an artificial intelligence electronic device), a person who uses the UE, or a device or apparatus using the UE.

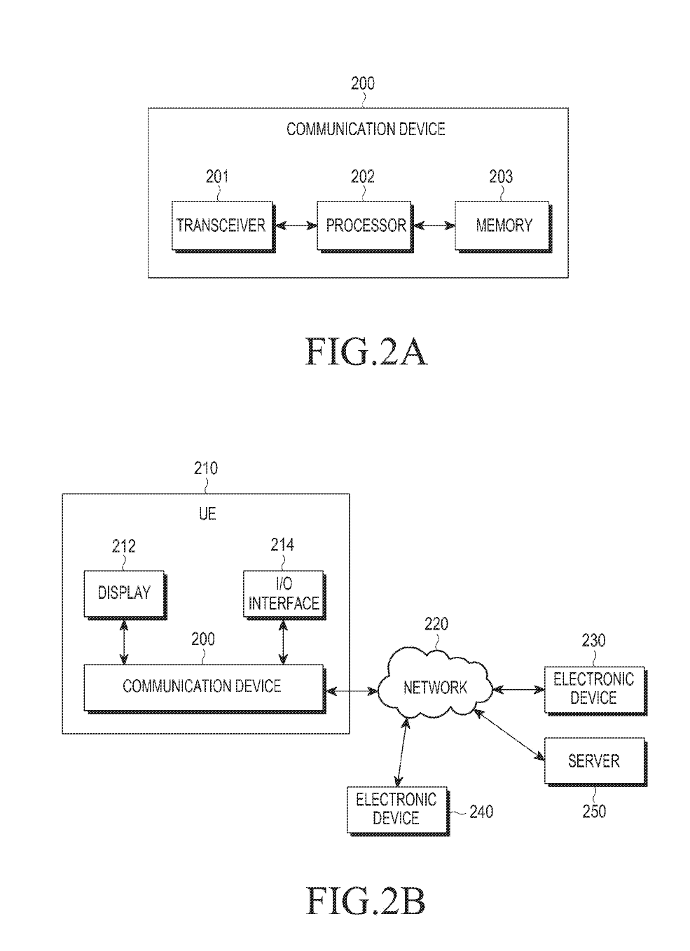

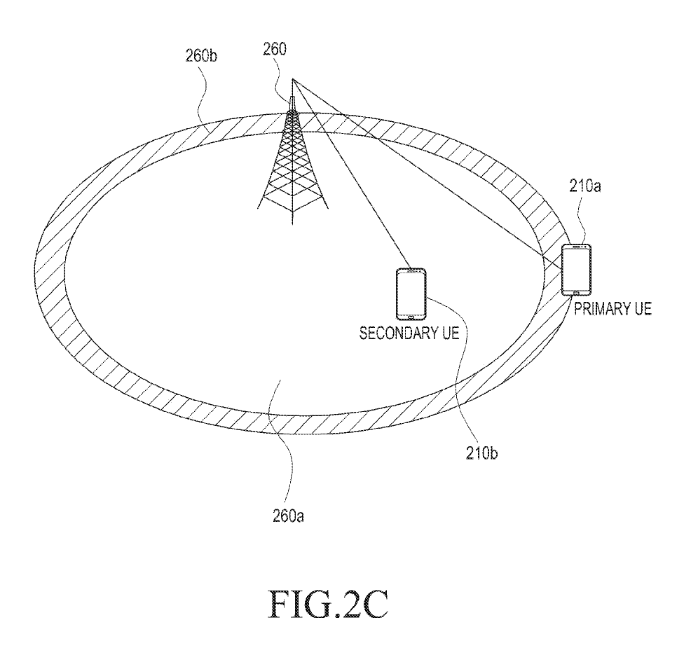

FIG. 2A is a diagram illustrating a communication device, according to an embodiment of the present disclosure. A communication device 200 includes a transceiver 201, a processor 202, and a memory 203.

The transceiver 201 sets up communication, for example, between the communication device 200 and an external device (e.g., a first external electronic device 230, a second external electronic device 240, or a server 250 of FIG. 2B). For example, the transceiver 201 may be connected to a network 220 (FIG. 2B) through wireless communication or wired communication in order to communicate with the external device. The transceiver 201 may also be referred to as a communication module or a communication interface.

The wireless communication may use, as a cellular communication protocol, at least one of LTE, LTE-A, code division multiple access (CDMA), wideband CDMA (WCDMA), universal mobile telecommunications system (UMTS), wireless broadband (WiBro), and global system for mobile communications (GSM). The wireless communication may also include short-range communication. The short-range communication may include at least one of wireless fidelity (WiFi), Bluetooth, near field communication (NFC), and global navigation satellite system (GNSS). Depending on a use area or a bandwidth, the GNSS may include at least one of global positioning system (GPS), global navigation satellite system (Glonass), Beidou navigation satellite system (Beidou), and Galileo, the European global satellite-based navigation system.

The wired communication may include at least one of universal serial bus (USB), high definition multimedia interface (HDMI), recommended standard-232 (RS-232), and plain old telephone service (POTS). The network 220 may include a telecommunications network, for example, at least one of a computer network (e.g., a local area network (LAN) or a wide area network (WAN)), Internet, and a telephone network.

The processor 202 may include a communication processor (CP). According to an embodiment of the present disclosure, the processor 202 may further include one or more of a CPU and an application processor (AP). The processor 202 performs an operation or data processing related to control and/or communication of at least one other element of the communication device 200. The term “processor” may be interchangeably used with various terms such as, for example, “control module”, “control unit”, and “controller”.

The memory 203 may include a volatile and/or non-volatile memory. The memory 203 stores a command or data related to at least one other element of the communication device 200. According to an embodiment of the present disclosure, the memory 203 stores software and/or a program. The program may include kernel, middleware, an application programming interface (API), and/or an application program (or an “application”). Although the memory 203 is illustrated as being included in the communication device 200 in FIG. 2A, this illustration is only an example used to describe the present disclosure. According to an embodiment of the present disclosure, the communication device 200 may be manufactured without the memory 203.

FIG. 2B is a diagram illustrating describing a UE including a communication device, according to an embodiment of the present disclosure.

Referring to FIG. 2B, a UE 210includes the communication device 200, a display 212, and an input/output (I/O) interface 214.

The display 212 may include, for example, a liquid crystal display (LCD), a light-emitting diode (LED) display, an organic light-emitting diode (OLED) display, a microelectromechanical systems (MEMS) display, or an electronic paper display. The display 212 may display various contents (e.g., text, an image, video, an icon, or a symbol) to a user. The display 212 may include a touch screen and may receive a touch, a gesture, proximity, or a hovering input, for example, by using an electronic pen or a part of a body of the user.

The I/O interface 214 serves as an interface for delivering a command or data input from a user or another external device to other component(s) of the UE 210. The I/O interface 214 may also output a command or data received from other component(s) of the UE 210 to a user or another external device.

According to an embodiment of the present disclosure, the UE 210 may further include a storage module (e.g., a memory) or a processor (e.g., an application processor).

FIG. 2C is a diagram illustrating a network system, according to an embodiment of the present disclosure.

Referring to FIG. 2C, a network includes a base station (BS) 260, a primary UE 210a, and a secondary UE 210b. The primary UE 210a is located at a cell edge 260b, and the secondary UE 210b is located in a cell interior 260a. A criterion for distinguishing the cell edge 260b from the cell interior 260a may be determined based on various criterions such as, for example, a distance from the BS 260 and a received signal strength of a UE. The communication device 200 may be included in a BS or a UE.

According to an embodiment of the present disclosure, downlink multiple input multiple output (MIMO) orthogonal frequency division multiplexing (OFDM) systems are considered in which at least one BS 260, having Nt transmission antennas mounted thereon, transmits messages to the primary UE, UE_{P}, 210a and the secondary UE, UEs, 210b, each having Nr reception antennas mounted thereon.

A first-order complex signal vector transmitted from the BS 260 at a k^{th} subcarrier may be expressed as xₖ=[xₖ¹, . . . , xₖ^{l}]^{T}, where xₖⁱ represents an i^{th} spatial layer at a subcarrier k, l represents the number of layers, and (·)^{T} represents a transpose of a vector. The symbol xₖⁱ is selected from a constellation set S(m) of an M term, where m=log₂ M. At the subcarrier k, a channel model from the BS 260 to the primary UE 210a and/or the secondary UE 210b may be expressed as an Nᵣ×Nₜ (Nᵣ-by-Nₜ) channel matrix Gₖ^{p} (Gₖ^{s}), which is modeled as a zero mean and a unit variance, that is, independent complex Gaussian probability variables having Rayleigh fading, in which an (r, t) entry indicates a path gain from an antenna t of the BS 260 to an antenna r of the primary UE 210a (or the secondary UE 210b ). An average transmission power of xₖⁱ is standardized to 1, that is, it is assumed that E [|xₖⁱ|²]=1. Here, E[·] represents an expectation operator, and |·| represents an absolute value of a complex number. rₖ^{p} is defined as an Nᵣ-dimensional complex received signal vector by the primary UE 210a at the subcarrier k. rₖ^{p} may be expressed as Equation (2) below:

rₖ^{p}=Hₖ^{p}xₖ+zₖ (2),

where Hₖ^{p} represents an effective channel matrix including distance-dependent path loss, an actual channel matrix Gₖ^{p}, a precoding matrix having a size of Nₜ×1(Nₜ-by-1), and an interference whitening process, and zₖ represents an interference-plus-noise term. Without loss of generality, elements of zₖ are assumed to be an independent and identically-distributed (IID) complex Gaussian having ,a variance of σₙ². Based on this assumption, a channel transition probability may be expressed as Equation (3) below:

$$p ( {r}_{k}^{p} \vert {x}_{k} ) = \frac{1}{{( {πσ}_{n}^{2} )}^{{N}_{r}}} exp ( - \frac{\vert \vert {r}_{k}^{p} - {H}_{k}^{p} {x}_{k} {\vert \vert}^{2}}{{σ}_{n}^{2}} ) , \qquad ( 3 )$$

where it is assumed that a whitening filter is obtained to have a target output variance σₙ². Similarily, a received signal vector in the secondary UE 210b may be expressed as Equation (4) below, and the channel transition probability may be, expressed as Equation (5) below.

$$\begin{matrix}{r}_{k}^{s} = {H}_{k}^{s} {x}_{k} + {z}_{k} & ( 4 ) \\ p ( {r}_{k}^{s} \vert {x}_{k} ) = \frac{1}{{( {πσ}_{n}^{2} )}^{{N}_{r}}} exp ( - \frac{\vert \vert {r}_{k}^{s} - {H}_{k}^{s} {x}_{k} {\vert \vert}^{2}}{{σ}_{n}^{2}} ) & ( 5 )\end{matrix}$$

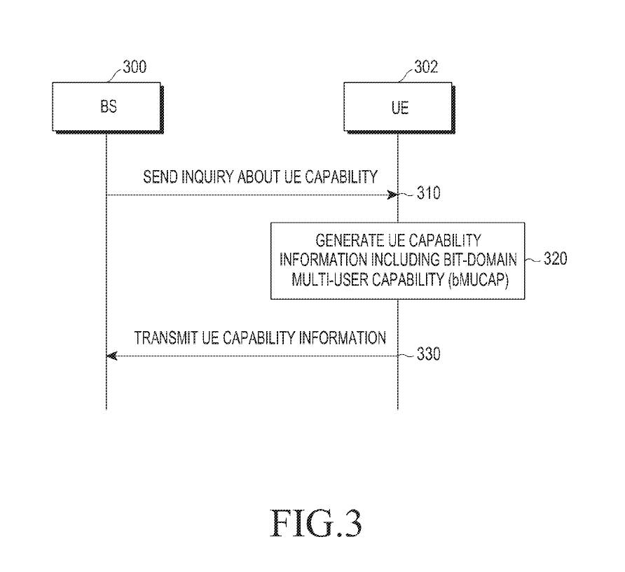

FIG. 3 is a diagram illustrating a function or an operation of transmitting UE capability information for bit-domain multi-user transmission, according to an embodiment of the present disclosure. A UE capability bit, for example, bit-domain multi-user capability (bMUCAP), may be defined to indicate, to a BS 300, whether a UE 302 is capable of supporting bit-domain multi-user transmission. Herein, if bMUCAP is set to 1, it indicates that a bit-domain multi-user transmission function or operation may be supported, and if bMUCAP is set to 0, it indicates that the bit-domain multi-user transmission function or operation may not be supported.

Referring to FIG. 3, the BS 300 sends, to the UE 302, an inquiry about UE capability, that is, whether the UE 302 is capable of supporting bit-domain multi-user transmission, in step 310. If the UE 302 supports bit-domain multi-user transmission, the UE 302 generates UE capability information including bit-domain multi-user capability to correspond to step 310, in step 320. The UE 302 transmits the generated UE capability information to the BS 300, in step 330.

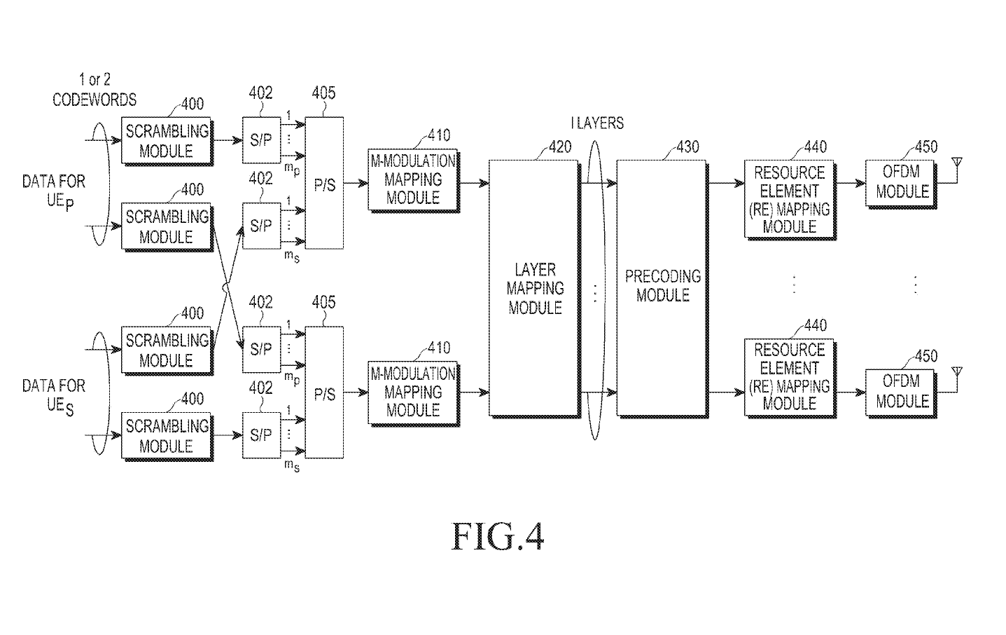

FIG. 4 is a diagram illustrating a function or an operation of a processor that performs bit-domain multi-user transmission, according to an embodiment of the present disclosure.

Referring to FIG. 4, data for the primary UE 210a and data for the secondary UE 210b are scrambled using a scrambling module 400. A serial-parallel module (S/P) 402 may perform converting serial data to parallel data. A parallel-serial module (P/S) 405 may perform converting parallel data to serial data. At least a part of the scrambled data (or data signal) may be cross inputted to an m-modulation mapping module 410, as shown in FIG. 4. The m-modulation mapping module 410 may superpose the input data signal in a bit domain. The m-modulation mapping module 410 allocates bits corresponding to the primary UE 210a to initial mₚ bit/bits having a high priority in a 2^{m}-QAM symbol (that is, a high projection level), and allocates bits corresponding to the secondary UE 210b to mₛ bit/bits having a low priority. Herein, m=mₚ+mₛ.

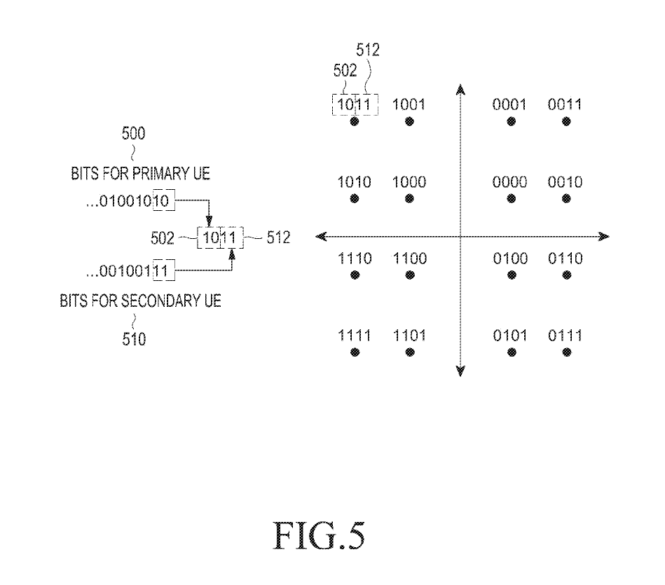

FIG. 5 is a diagram illustrating a function or an operation of performing superposition coding in a bit domain, according to an embodiment of the present disclosure. Referring to FIG. 5, the m-modulation mapping module 410 superposes some bits 502 (e.g., “10”) of bits 500 for the primary UE 210a and some bits 512 (e.g., “11”) of bits 510 for the secondary UE 210b. The bits superposed in this way may be expressed on a coordinate plane 16QAM shown in FIG. 5.

Referring back to FIG. 4, a layer mapping module 420 performs mapping with respect to signals or symbols output from the m-modulation mapping module 410 between 1 layers.

A precoding module 430 performs precoding with respect to a signal output from the layer mapping module 420.

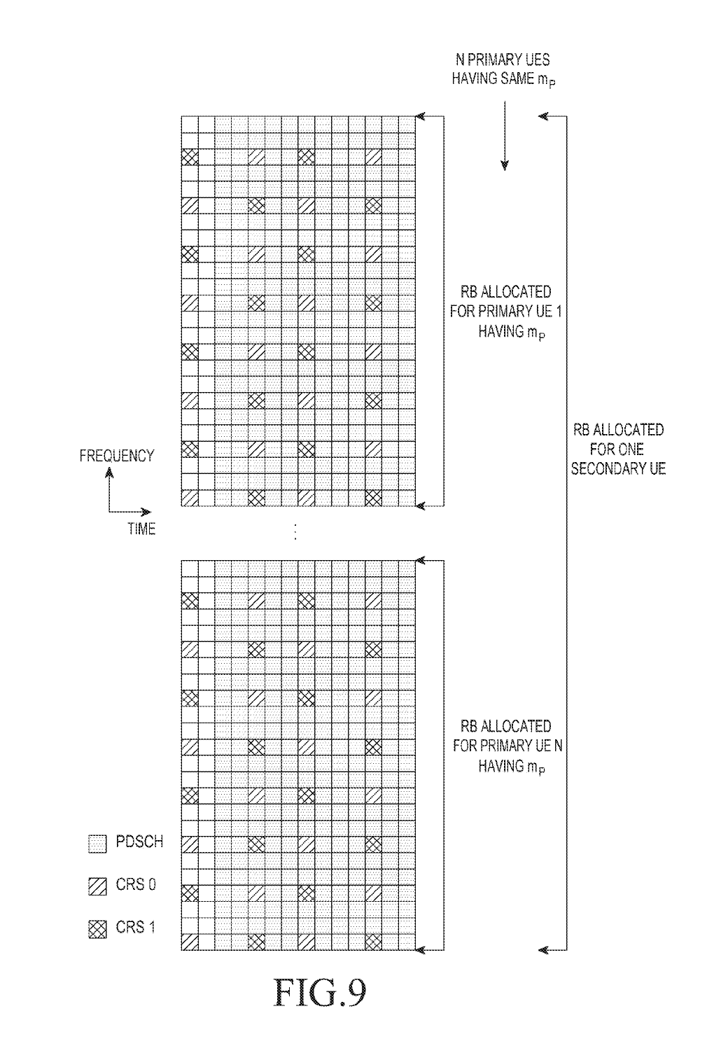

An RE mapping module 440 performs RE/REs mapping for the primary UE 210a and the secondary UE 210b. The RE mapping module 440 may map an RE/REs for the primary UE 210a and the secondary UE 210b, for example, as shown in FIG. 9. According to an embodiment of the present disclosure, the mapped RE/REs are included in the same (or a single) subframe and transmitted to the primary UE 210a and the secondary UE 210b. As shown in FIG. 9, co-scheduling for N primary UEs receiving the same number of bits, mₚ, and one secondary UE may be allocated. The N primary UEs may include a UE that supports bit-domain multi-user transmission or a legacy UE that does not support the bit-domain multi-user transmission. Co-scheduling for one primary UE and N secondary UEs receiving the same number of bits, mₛ, may be allocated. The one primary UE may include a UE that supports bit-domain multi-user transmission or a legacy UE that does not support the bit-domain multi-user transmission. Co-scheduling for N secondary UEs receiving the same number of bits, mₛ, and one primary UE may be allocated.

An OFDM module 450 performs OFDM with respect to resources (or symbols) mapped by the RE mapping module 440.

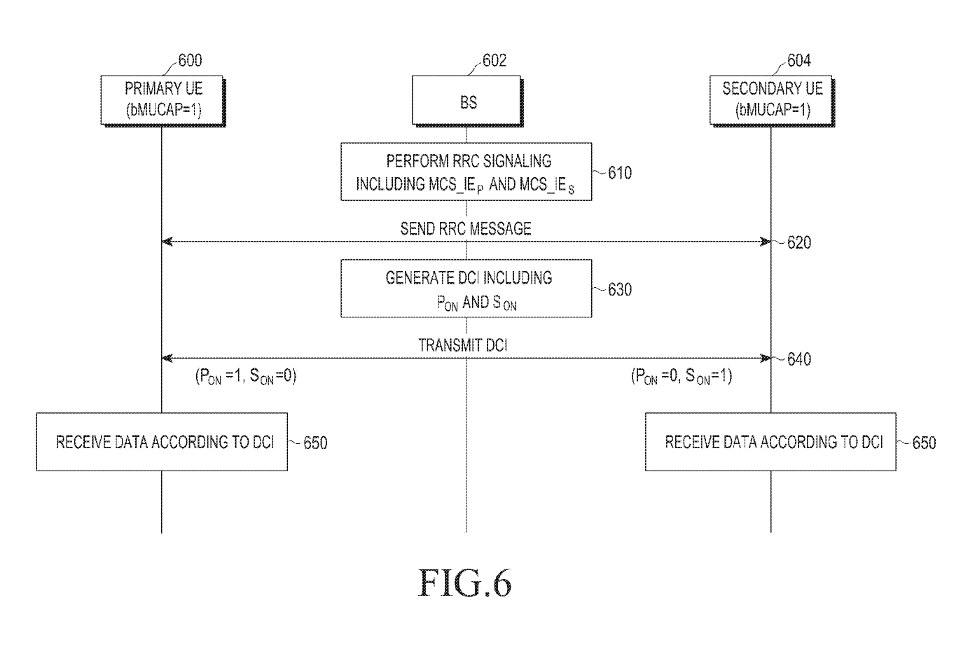

FIG. 6 is a diagram illustrating a function or an operation of transmitting IEs necessary for a primary UE and a second UE based on RRC signaling, and transmitting ID information for selecting a primary UE mode or a secondary UE mode to each UE based on DCI signaling, for bit-domain multi-user transmission, according to an embodiment of the present disclosure.

According to an embodiment of the present disclosure, in order to allow the primary UE 210a and the secondary UE 210b to have knowledge of primary and/or secondary operations, IE and/or ID information may be transmitted to the respective UEs 210a and 210b. For example,

FIG. 6 shows a procedure of providing IEs for modulation and coding schemes (MCS) to be used by the primary UE 210a and the secondary UE 210b, expressed as MCS_IEₚ and MCS_IEₛ, to a UE. Herein, the term “IE” may refer to information about a counterpart UE included for MUST (MCS/coding information) and may be transmitted to a UE by RRC or DCI. The term “ID information” may refer to information for selecting whether a reception UE is in a primary UE mode or a secondary UE mode, and may be transmitted to a UE by DCI. MCS_IE_{P} and MCS_IE_{S} may include an MCS index, a new data indicator redundancy version, or precoding information. The MCS may include the number of bits mₚ or mₛ for the primary UE and the secondary UE. To allow the respective UEs 210a and 210b to recognize whether they are the primary UE 210a or the secondary UE 210b, DCI including fields P_{ON} and S_{ON} may be transmitted to the respective UEs 210a and 210b.

Referring to FIG. 6, a BS 602 performs RRC signaling including MCS_IE_{P} and MCS_IE_{S}, in step 610. The BS 602 sends an RRC message to at least one of UEs 600 and 604, in step 620. The BS 602 generates DCI including the field P_{ON} and the field S_{ON}, in step 630. The field P_{ON} may include an indicator indicating a primary UE, and the field S_{ON} may include an indicator indicating a secondary UE. For example, for P_{ON}=1, it may indicate that a corresponding UE is a primary UE, and for S_{ON}=1, it may indicate that a corresponding UE is a secondary UE. The BS 602 transmits the DCI to the at least one of UEs 600 and 604, in step 640. For example, the DCI transmitted to the primary UE 600 may include 1 in the field P_{ON} and 0 in the field S_{ON}. Likewise, the DCI transmitted to the secondary UE 604 may include 0 in the field P_{ON} and 1 in the field S_{ON}. Each of the UEs 600 and 604 having received the DCI may receive (or detect) data according to the received DCI. Each of the UEs 600 and 604 detects data by using information about an MCS of the secondary UE 604, which is expressed as MCS_IE_{S} (or an MCS of the primary UE 600, expressed as MCS_IE_{P}), in step 650. An operation or a function for detecting the data is described in greater detail below.

According to an embodiment of the present disclosure, only MCS_IE_{P} may be transmitted to the primary UE 600 and only MCS_IE_{S} may be transmitted to the secondary UE 604. However, according to another embodiment of the present disclosure, both MCS_IE_{P} and MCS_IE_{S} may be transmitted to each of the UEs 600 and 604.

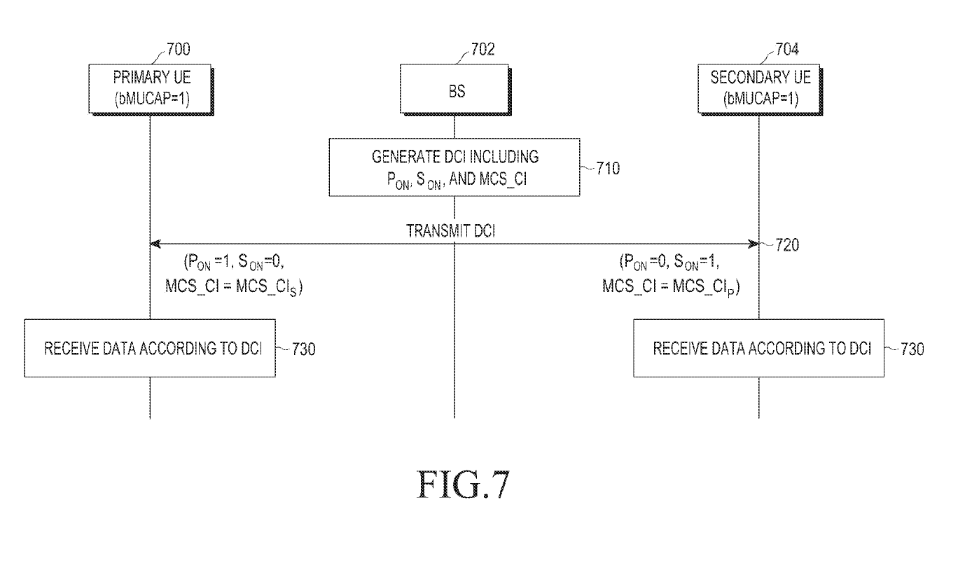

According to an embodiment of the present disclosure, function/functions or operation/operations described with reference to FIG. 6 may be performed by defining DCI to include a new field expressed as MCS_CI. FIG. 7 is a diagram illustrating a function or an operation of transmitting IEs necessary for a primary UE and a secondary UE, and ID information based on DCI signaling for bit-domain multi-user transmission.

Referring to FIG. 7, a BS 702 generates DCI including a field P_{ON}, a field S_{ON}, and a field MCS_CI, in step 710. The BS 702 transmits the DCI to at least one of UEs 700 and 704, in step 720. To perform bit-domain multi-user transmission, the primary UE 700 may need information about the secondary UE 704 and the secondary UE 704 may need information about the primary UE 700. Thus, the DCI transmitted to the primary UE 700 may include P_{ON}=1, S_{ON}=0, and MCS_CI=MCS_CI_{S}. MCS_CI_{S} may include information about an MCS of the secondary UE 704. The DCI transmitted to the secondary UE 704 may include P_{ON=}0, S_{ON}=1, and MCS_CI=MCS_CI_{P}. MCS_CI_{P} may include information about an MCS of the primary UE 700. Each of the UEs 700 and 704 having received the DCI may receive (or detect) data according to the received DCI, in step 730. Each of the UEs 700 and 704 may detect data by using the information about the MCS of the secondary UE 704, expressed as MCS_CI_{S} (or the MCS of the primary UE 700, expressed as MCS_CI_{P}).

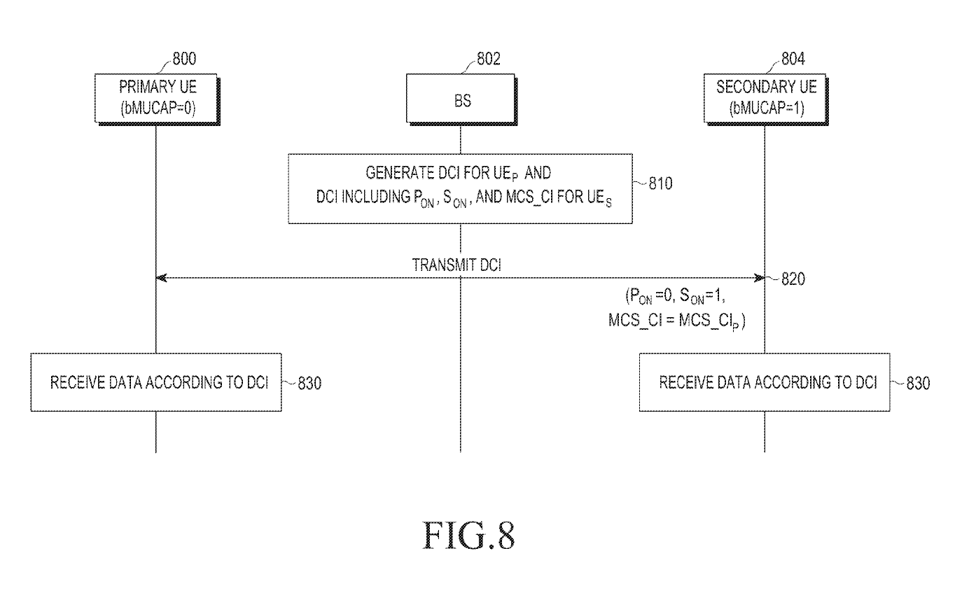

FIG. 8 is a diagram illustrating DCI signaling for bit-domain multi-user transmission including a legacy UE that does not support bit-domain multi-user transmission, according to an embodiment of the present disclosure. Herein, the legacy UE (e.g., a primary UE 800 that does not support a bit-domain multi-user transmission function or operation) is assumed to have the capability of processing data notified (or transmitted) by legacy DCI modulated using 4QAM modulation in a normal single-user transmission mode. However, data may be transmitted to the legacy UE 800 according to a proposed multi-user transmission scheme having mₚ=2 and mₛ≧1. In spite of such a discrepancy, the legacy UE 800 may restore the transmitted data by estimating log likelihood ratio (LLR) values based on characteristics of gray coding QAM schemes used in an LTE-A system, assuming that the received data is modulated by 4QAM modulation.

Referring to FIG. 8, a BS 802 generates legacy DCI for the primary UE 800 and DCI including a field P_{ON}, a field S_{ON}, and a field MCS_CI, in step 810. The BS 802 transmits the generated DCI to at least one of UEs 800 and 804, in step 820. The at least one of UEs 800 and 804 having received the DCI receive (or detect) data according to the received DCI, in step 830.

Using such a function/functions or an operation/operations, compatibility with the legacy UE 800, which is incapable of supporting a scheme proposed according to the present disclosure in terms of 3GPP standards, may be secured. According to an embodiment of the present disclosure, the primary UE (e.g., the primary UE 800) including the legacy UE 800 and the secondary UE (e.g., the secondary UE 804), which include the same mₚ, may be co-scheduled as shown in FIG. 9.

FIG. 9 is a diagram illustrating a mapping structure of resource blocks for co-scheduling of bit-domain multi-user transmission, according to an embodiment of the present disclosure. A description of multi-user detection in which the primary UE detects data according to the DCI is set forth below.

b_{k,i,μ} is assumed to be a μ^{th} bit (μ=1, 2, . . . , m) of the constellation symbol xₖⁱ. L(b_{k,i,μ}) may be expressed as an LLR with respect to the bit b_{k,i,μ}, which is defined as set forth in Equation (6) below:

$$L ( {b}_{k , i , μ} ) = log \frac{P ( {b}_{k , i , μ} = 1 )}{P ( {b}_{k , i , μ} = 0 )} , \qquad ( 6 )$$

where P(b_{k,i,μ}=b) represents a probability that the probability variable b_{k,i,μ} has a value b (b=0 or 1). With the conditions of a channel matrix Hₖ^{p} and a received signal vector rₖ^{p}, an LLR Lₚ₂ₚ (b_{k,i,μ}) for the primary UE 210a may be expressed as set forth in Equation (7) below.

$${L}_{p 2 p} ( {b}_{k , i , μ} ) = log \frac{P ( {b}_{k , i , μ} = 1 \vert {r}_{k}^{p} , {H}_{k}^{p} )}{P ( {b}_{k , i , μ} = 0 \vert {r}_{k}^{p} , {H}_{k}^{p} )} \qquad ( 7 )$$

When χ(m) is a set of all possible symbol vectors xₖⁱ that may be produced by one-time Cartesian product of S(m), then the LLR Lₚ₂ₚ(b_{k,i,μ}) may be expressed as set forth in Equation (8) below:

$${L}_{p 2 p} ( {b}_{k , i , μ} ) = log \frac{{Σ}_{{x}_{k} ∈ {χ}_{1}^{i , μ} ( m )} p ( {r}_{k}^{p} \vert {x}_{k} )}{{Σ}_{{x}_{k} ∈ {χ}_{0}^{i , μ} ( m )} p ( {r}_{k}^{p} \vert {x}_{k} )} , for 1 \leq μ \leq {m}_{p} , \qquad ( 8 )$$

where χ_{b}^{i,μ}(m) represents a set of all symbol vectors xₖ of χ(m) corresponding to b_{k,i,μ}=b (b=0 or 1). The primary UE 210a receives or detects data (e.g., the bit b_{k,i,μ}) by using Equation (7) or Equation (8).

To derive Equation (8), it is assumed that a modulation parameter mₛ of the secondary UE 210b is known to the primary UE 210a. The modulation parameter mₛ may be transmitted to the primary UE 210a through RRC or DCI signaling, as shown in FIG. 6 or 7, respectively, and may be used by the primary UE 210a. In FIG. 8, it is described that for m_{(legacy(l))}=mₚ, the primary UE, which is the served legacy UE, may estimate the LLR with 2^{m}sl-QAM without the parameter mₛ. For backward compatibility (BWC) with a previous version, the LLR may be expressed as Equation (9) below.

$${L}_{p 2 p}^{BWC} ( {b}_{k , i , μ} ) \approx log \frac{{Σ}_{{x}_{k} ∈ {χ}_{1}^{i , μ} ( {m}_{p} )} p ( {r}_{k}^{p} \vert {x}_{k} )}{{Σ}_{{x}_{k} ∈ {χ}_{0}^{i , μ} ( {m}_{p} )} p ( {r}_{k}^{p} \vert {x}_{k} )} , for 1 \leq μ \leq {m}_{p} \qquad ( 9 )$$

Cardinalities of χ_{b}^{i,μ}(m) of Equation (8) and χ_{b}^{i,μ}^{ₚ}(m) of Equation (9) may be given as 2^{lm-1} and 2^{lm}^{ₚ}⁻¹, respectively, which mean different computational complexities.

Bit-interleaved coded modulation (BICM) separates an MIMO detector and a decoder through a bit-level interleaver, and each coded bit experiences different qualities of channels. Due to the interleaver, all bits are assumed to be independent of each other. In this case, mutual information M_{k,i,μ} of a bit channel for b_{k,i,μ} may be expressed as set forth in Equation (10) below.

$${k , i , μ}_{} = 1 - {E}_{b , {X}_{k} , {H}_{k}^{p}} [ log \frac{{Σ}_{{x}_{k} ∈ {χ}_{1}^{i , μ} ( m )} p ( {r}_{k}^{p} \vert {x}_{k} )}{{Σ}_{{x}_{k} ∈ {χ}_{0}^{i , μ} ( m )} p ( {r}_{k}^{p} \vert {x}_{k} )} ] \qquad ( 10 )$$

An average BICM capacity for the primary UE 210a may be expressed in bps/Hz as set forth in Equation (11) below.

$$\begin{matrix}{C}_{p , k}^{BICM} = {\sum }_{i = 1}^{l} {\sum }_{μ = 1}^{{m}_{p}} {ℳ}_{k , i , μ} \\ = {lm}_{p} - {\sum }_{i = 1}^{l} {\sum }_{μ = 1}^{{m}_{p}} {E}_{b , {x}_{k} , {H}_{k}^{p}} [ log \frac{{Σ}_{{x}_{k} ∈ χ ( m )} p ( {r}_{k}^{p} \vert {x}_{k} )}{{Σ}_{{x}_{k} ∈ {χ}_{o}^{i , μ} ( m )} p ( {r}_{k}^{p} \vert {x}_{k} )} ]\end{matrix} \qquad ( 11 )$$

The primary UE 210a calculates an average BICM capacity for the primary UE 210a by using Equation (11).

Multi-user detection in the secondary UE 210b is described in greater detail below. If only a modulation level mₚ is available in the secondary UE 210b, a maximum likelihood (ML) detector that does not use iterative detection and decoding (IDD) may be used. In this case, an LLR Lₛ₂ₛ^{ML}(b_{k,i,μ}) may be calculated as set forth in Equation (12) below.

$${L}_{s 2 s}^{ML} ( {b}_{k , i , μ} ) = log \frac{{Σ}_{{x}_{k} ∈ {χ}_{1}^{i , μ} ( m )} p ( {r}_{k}^{s} \vert {x}_{k} )}{{Σ}_{{x}_{k} ∈ {χ}_{0}^{i , μ} ( m )} p ( {r}_{k}^{s} \vert {x}_{k} )} , for m - {m}_{s} + 1 \leq μ \leq m \qquad ( 12 )$$

However, if information about an MCS used by the primary UE 210a is known to the secondary UE 210b, the IDD scheme may be applied.

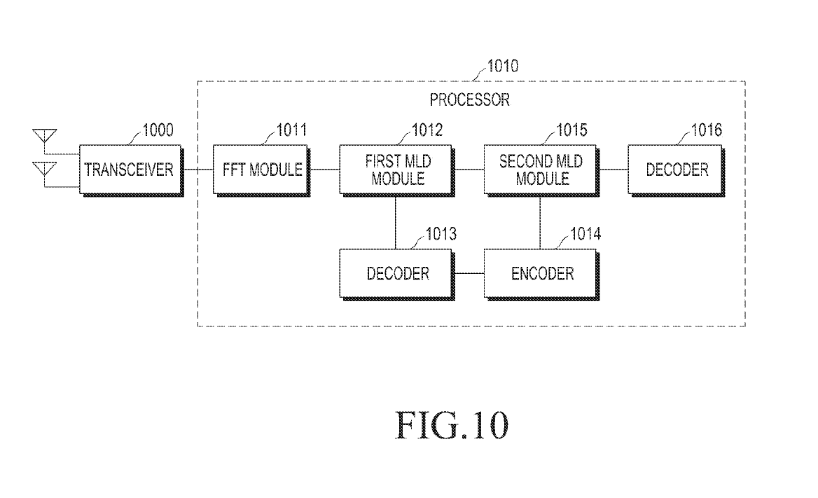

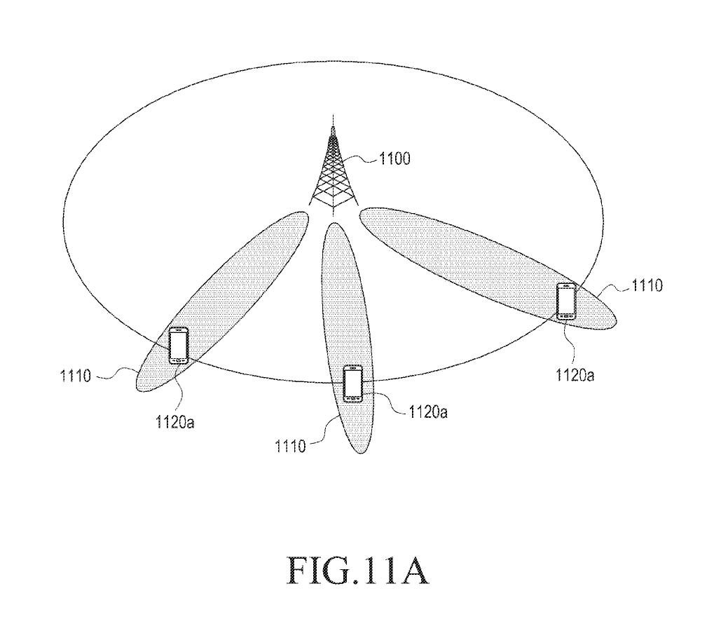

FIG. 10 is a diagram illustrating multi-user detection for a secondary UE, according to an embodiment of the present disclosure. Referring to FIG. 10, the secondary UE 210b includes a transceiver 1000 and a processor 1010. The processor 1010 includes a fast Fourier transform (FFT) module 1011, a first maximum likelihood detection (MLD) module 1012, decoders 1013 and 1016, an encoder 1014, and a second MLD module 1015.

The transceiver 1000 transmits and receives various signals. The FFT module 1011 performs FFT with respect to a received signal.

The first MLD module 1012 detects bit/bits b_{k,i,μ}(μ=1, . . . , mₚ) of the primary UE 210a. Assuming the use of MLD for detection of the bit/bits b_{k,i,μ} of the primary UE 210a, an LLR may be calculated as set forth in Equation (13) below.

$${L}_{p 2 s} ( {b}_{k , i , μ} ) = log \frac{{Σ}_{{x}_{k} ∈ {χ}_{1}^{i , μ} ( m )} p ( {r}_{k}^{s} \vert {x}_{k} )}{{Σ}_{{x}_{k} ∈ {χ}_{0}^{i , μ} ( m )} p ( {r}_{k}^{s} \vert {x}_{k} )} , for 1 \leq μ \leq {m}_{p} \qquad ( 13 )$$

According to an embodiment of the present disclosure, the first MLD module 1012 may detect b_{k,i,μ} by using a linear minimum mean squared error (MMSE) instead of MLD. After being decoded by the decoder 1013, the detected b_{k,i,μ} is encoded by the encoder 1014. Herein, the encoded b_{k,i,μ} may also be referred to as \hat{b}_{k,i,μ}.

According to an embodiment of the present disclosure, if information about an MCS scheme used by the primary UE 210a is known to the secondary UE 210b, the encoded bit \hat{b}_{k,i,μ} may be regarded as a correct bit. In this case, an LLR for bit/bits of the secondary UE 210b may be expressed as Equation (14) below:

$${L}_{s 2 s}^{IDD} ( {b}_{k , i , μ} ) \approx log \frac{{Σ}_{{x}_{k} ∈ {χ}_{1}^{i , μ} ( m , {b}_{k , i , 1 \text{:} {m}_{p}} )} p ( {r}_{k}^{p} \vert {x}_{k} )}{{Σ}_{{x}_{k} ∈ {χ}_{0}^{i , μ} ( m , {b}_{k , i , 1 \text{:} {m}_{p}} )} p ( {r}_{k}^{p} \vert {x}_{k} )} , for m - {m}_{s} + 1 \leq μ \leq m , \qquad ( 14 )$$

where χ_{b}^{i,μ}(m, b_{k,i,1:m}_{ₚ}) represents a set of all symbol vectors in χ_{b}^{i,μ} (m) having b_{k,i,μ} for 1≦μ≦mₚ, which is the same as \hat{b}_{k,i,μ}. Equation (14) shows that the computational complexity of second state MLD is proportional to the number of vectors in a search set χ_{b}^{i,μ}(m, b_{k,i,1:m}_{ₚ}) having a cardinality of 2^{lm}^{ₛ}<<2^{lm}.

According to an embodiment of the present disclosure, the secondary UE 210b only performs decoding and encoding with respect to symbols related to symbols used by the primary UE 210a, without having to perform decoding with respect to all symbols, thereby reducing computational complexity. For example, referring to FIG. 5, although decoding and encoding are performed on all superposed symbols, if bits detected by the first MLD module 1012 are “10”, the secondary UE 210b needs to only perform decoding on symbols (that is, “1010”, “1000”, “1011”, and “1001”) located in a second quadrant.

An average BICM capacity of the secondary UE 210b for MLD and IDD may be calculated as set forth in Equation (16) below.

$$\begin{matrix}{C}_{s , k}^{BICM , ML} = {lm}_{s} - {\sum }_{i = 1}^{l} {\sum }_{μ = m - {m}_{s} + 1}^{m} {E}_{b , {x}_{k} , {H}_{k}^{s}} [ log \frac{{Σ}_{{x}_{k} ∈ χ ( m )} p ( {r}_{k}^{s} \vert {x}_{k} )}{{Σ}_{{x}_{k} ∈ {χ}_{0}^{i , μ} ( m )} p ( {r}_{k}^{s} \vert {x}_{k} )} ] & ( 15 ) \\ {C}_{s , k}^{BICM , IDD} = {lm}_{s} - {\sum }_{i = 1}^{l} {\sum }_{μ = m - {m}_{s} + 1}^{m} {E}_{b , {x}_{k} , {H}_{k}^{s}} [ log \frac{{Σ}_{{x}_{k} ∈ χ ( m , {b}_{k , i , 1 \text{:} {m}_{p}} )} p ( {r}_{k}^{s} \vert {x}_{k} )}{{Σ}_{{x}_{k} ∈ {χ}_{0}^{i , μ} ( m , {b}_{k , i , 1 \text{:} {m}_{p}} )} p ( {r}_{k}^{s} \vert {x}_{k} )} ] & ( 16 )\end{matrix}$$

Multi-user detection, according to an embodiment of the present disclosure, may be applied to modulation for different d1 and d2, that is, having non-uniform signal constellation.

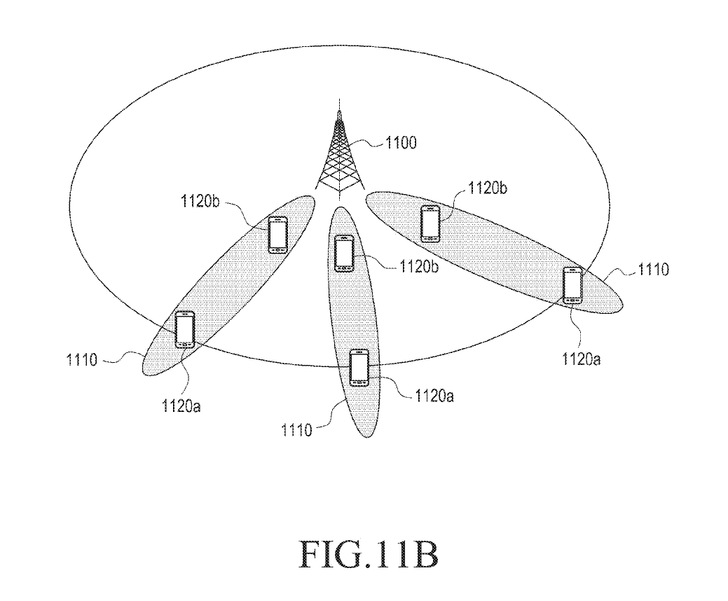

FIG. 11 A is an diagram illustrating a transmission scheme that supports one UE for each beam domain formed by full dimension (FD)-MIMO, according to an embodiment of the present disclosure. FIG. 11B is a diagram illustrating a multi-user transmission scheme supporting a plurality of UEs for each beam domain formed by FD-MIMO, to which a bit-domain multi-user transmission scheme is applied.

Referring to FIG. 11A, a BS 1100 and one primary UE 1120a transmit and receive data through a beam domain 1110 generated according to FD-MIMO. Bit-domain multi-user transmission, according to an embodiment of the present disclosure, may be applied to the FD-MIMO system. Referring to FIG. 11B, when bit-domain multi-user transmission is applied to the FD-MIMO system, the primary UE 1120a and at least one secondary UE 1120b may communicate with the BS 1100 and/or a counterpart UE through each beam domain 1110, thereby improving the throughput of the FD-MIMO system using bit-domain multi-user transmission.

The term “module” or “functional unit”, as used herein, may mean, for example, a unit including one of or a combination of two or more of hardware, software, and firmware. The term “module” may be interchangeably used with the terms “unit”, “logic”, “logical block”, “component”, or “circuit”. A module or functional unit may be a minimum unit or a portion of an integrated component. A module or functional unit may be a minimum unit or a portion thereof performing one or more functions. A module or functional unit may be implemented mechanically or electronically. For example, a module or functional unit may include at least one of an application-specific integrated circuit (ASIC) chip, field-programmable gate arrays (FPGAs), and a programmable-logic device performing certain operations already known or to be developed.

At least a part of a device (for example, modules or functions thereof) or a method (for example, operations), according to embodiments of the present disclosure, may be implemented with a command stored in a computer-readable storage medium in the form of a program module. When the command is executed by a processor (for example, the processor 202), one or more processors may perform a function corresponding to the command. The computer-readable storage medium may be, for example, the memory 203.

The computer readable recording medium includes a hard disk, a floppy disk, magnetic media (e.g., magnetic tape), optical media (e.g., compact disc read only memory (CD-ROM) or digital versatile disc (DVD)), magneto-optical media (e.g., floptical disk), and a hardware device (e.g., ROM, RAM, or flash memory). Further, the program instructions include a machine language code created by a complier and a high-level language code executable by a computer using an interpreter. The foregoing hardware device may be configured to be operated as at least one software module to perform an operation of the present disclosure, or vice versa.

Modules or programming modules, according to embodiments of the present disclosure, may include one or more of the foregoing elements, may omit some of the foregoing elements, or may include additional elements. Operations performed by the modules, the programming modules, or other elements may be executed in a sequential, parallel, repetitive or heuristic manner. Also, some of the operations may be executed in a different order, may be omitted, or may have additional operations.

The present disclosure may be utilized in conjunction with the manufacture of integrated circuits, chip sets, or system-on-chips (SoCs). One skilled in the art would know how to dice wafers and package die to produce integrated circuits. Integrated circuits so manufactured are considered part of this disclosure.

As is apparent from the foregoing description, according to embodiments of the present disclosure, a network system may be provided that has an improved system throughput by performing superposition coding at a bit level.

While the disclosure has been shown and described with reference to certain embodiments thereof, it will be understood by those skilled in the art that various changes in form and detail may be made therein without departing from the spirit and scope of the disclosure as defined by the appended claims.

What is claimed is:

1. A communication device comprising:
a transceiver; and
a processor, electrically connected with the transceiver, and configured to superpose first data corresponding to at least one first user equipment (UE) and second data corresponding to at least one second UE at a bit level to generate superposed data, to modulate the superposed data, and to transmit the modulated data to the at least one first UE and the at least one second UE.

2. The communication device of claim 1, wherein the processor is further configured to control the transceiver to transmit first modulation and coding information about the at least one first UE to the at least one second UE, and to transmit second modulation and coding information about the at least one second UE to the at least one first UE.

3. The communication device of claim 2, wherein the first and second modulation and coding information is transmitted through a radio resource control (RRC) message.

4. The communication device of claim 1, wherein the first and second modulation and coding information is transmitted through downlink control information (DCI).

5. The communication device of claim 1, wherein the at least one first UE is located in a cell edge region, and the at least one second UE is located in a cell interior region.

6. The communication device of claim 1, wherein, when the at least one second UE comprises a plurality of second UEs, the processor is further configured to control the transceiver to receive information about co-scheduling for the first UE and the plurality of second UEs having a same number of bits.

7. The communication device of claim 1, wherein, when the at least one first UE comprises a plurality of first UEs, the processor is further configured to control the transceiver to receive information about co-scheduling for the plurality of first UEs having a same number of bits and the second UE.

8. The communication device of claim 7, wherein the at least one first UE does not support bit-domain multi-user transmission.

9. A method for controlling a communication device, the method comprising:
superposing first data corresponding to at least one first user equipment (UE) and second data corresponding to at least one second UE at a bit level to generate superposed data;
modulating the superposed data; and
transmitting the modulated data to the at least one first UE and the at least one second UE.

10. The method of claim 9, further comprising:
transmitting first modulation and coding information about the at least one first UE to the at least one second UE, and second modulation and coding information about the at least one second UE to the at least one first UE.

11. The method of claim 10, wherein the first and second modulation and coding information is transmitted through a radio resource control (RRC) message.

12. The method of claim 9, wherein the first and second modulation and coding information is transmitted through downlink control information (DCI).

13. The method of claim 9, wherein the at least one first UE is located in a cell edge region, and the at least one second UE is located in a cell interior region.

14. The method of claim 9, further comprising:
when the at least one first UE comprises a plurality of first UEs, receiving information about co-scheduling for the plurality of first UEs having a same number of bits and the at least one second UE.

15. The method of claim 14, wherein the at least one first UE does not support bit-domain multi-user transmission.

16. A method for controlling a communication device, the method comprising:
scrambling first data corresponding to at least one first user equipment (UE) and second data corresponding to at least one second UE;
superposing the scrambled first data and the scrambled second data in a bit domain to generate superposed data;
mapping the superposed data between a specified number of layers;
precoding the superposed data mapped between the specified number of layers to generate precoded data;
transmitting the precoded data to the at least one first UE and the at least one second UE.

17. The method of claim 16, wherein superposing the scrambled first data and the scrambled second data comprises cross-inputting at least a portion of the scrambled first data and at least a portion of the scrambled second data.

18. The method of claim 16, wherein the at least one first UE is located in a cell edge region, and the at least one second UE is located in a cell interior region.

19. The method of claim 18, wherein superposing the scrambled first data and the scrambled second data comprises allocating first bits having a high priority to the at least one first UE, and allocating second bits having a low priority to the at least one second UE.

20. The method of claim 16, wherein transmitting the precoded data comprises performing resource element (RE) mapping and orthogonal frequency division multiplexing (OFDM) with respect to the precoded data for the at least one first UE and the at least one second UE.
